(19) United States
(12) Patent Application Publication
(10) Pub. No.: US 2026/0054625 A1
(43) Pub. Date: Feb. 26, 2026

(54) VEHICLE SEAT

(71) Applicant: GRAMMER Aktiengesellschaft, Ursensollen (DE)

(72) Inventors: KONSTANTIN KRIVENKOV, Amberg (DE); SEBASTIAN KECK, Freudenberg (DE); PETER HOFMANN, Ammerthal (DE); ANDREAS NIEBLER, Am Wäldchen 2a (DE)

(21) Appl. No.: 19/250,967

(22) Filed: Jun. 26, 2025

(30) Foreign Application Priority Data
Aug. 2, 2024 (DE) 102024122177.1

(51) Int. Cl. B60N 2/72; A47C 7/18

(52) U.S. Cl. CPC B60N 2/72; A47C 7/18

(57) ABSTRACT

A vehicle seat for commercial vehicles includes a support structure and at least one cushion element. The at least one cushion element is arranged on the support structure. The support structure includes at least one shell element. The at least one cushion element is formed from an integral foam and has a plurality of openings.

### CROSS-REFERENCE TO RELATED APPLICATIONS

This application claims priority to German Patent Application 102024122177.1, filed on Aug. 2, 2024, the contents of which are incorporated by reference herein in their entirety.

### TECHNICAL FIELD

The invention relates to a vehicle seat for commercial vehicles comprising a support structure and at least one cushion element, wherein the at least one cushion element is arranged on the support structure.

### BACKGROUND

Fields of application for the present invention are, in particular, commercial vehicles without a cab or with an open cab. Such commercial vehicles can be, for example, ride-on lawn mowers, small tractors, forklift trucks and construction machinery. In such commercial vehicles, a simple, robust vehicle seat is usually desired. Typically, such vehicle seats have a support structure, such as a linkage. A cushion element is arranged on this support structure. A protective cover is arranged on the cushion element to protect it from mechanical influences and/or the effects of the weather.

Such vehicle seats often have the disadvantage that the occupant is sweaty due to the long contact with the seat. Another disadvantage is that the absence of a cabin or the open cabin means that this type of vehicle seat often gets dirty.

The problem to be solved is to provide a vehicle seat which overcomes the disadvantages mentioned at the beginning.

### SUMMARY

The core idea of the invention is a vehicle seat for commercial vehicles. A vehicle seat for commercial vehicles comprising a support structure and at least one cushion element, wherein the at least one cushion element is arranged on the support structure, wherein the support structure comprises at least one shell element, wherein the at least one cushion element is formed from an integral foam, wherein the at least one cushion element has a plurality of openings.

Integral foams are foams with a comparatively large-pored interior and a compact surface with a closed outer skin. The robust, viscoplastic outer skin provides a high level of protection. The at least one cushion element is therefore extremely robust against mechanical influences and/or the effects of the weather. It is therefore not necessary to provide a protective cover. Advantageously, the at least one cushion element therefore has no cover. The integral foam is preferably a polyurethane (PUR) integral foam. Polyurethane is robust, permanently elastic, easy to clean and resistant to oils, solvents and many chemicals. The shape of the at least one cushion element and/or the nature of the outer skin can be predetermined by specifying the mould during manufacture.

The hardness of the polyurethane (PUR) can advantageously be varied by selecting the starting materials. Advantageously, the at least one cushion element has sufficient elasticity to enable comfortable sitting.

According to the invention, the provision of the openings in the at least one cushion element reduces the temperature and humidity in the area of contact of the occupant with the surface of the at least one cushion element. Passive cooling is thus provided. In addition, the provision of openings in the at least one cushion element enables improved usability under poor weather and working conditions. As the extent of the surface is reduced, less soiling and less moisture remains on the surface of the at least one cushion element, which comes into contact with the occupant. The mass of the at least one cushion element is also reduced by the provision of the openings in the at least one cushion element. This reduces the manufacturing costs of the vehicle seat.

According to a particularly preferred embodiment, the openings are provided in areas of the at least one cushion element in which a lower contact pressure is to be expected due to an occupant. Typically, the sitting position of the occupant in the seat results in areas in which the pressure on the at least one cushion element is greater. One such area is, for example, the contact area of the cushion element with the ischium of the occupant. Another such area with high contact pressure is the contact area of the thighs at the front end of the seat section. In the back section, there is increased contact pressure in the lumbar region at the outer lateral edge of the back. Increased contact pressure can also be expected in the shoulder area.

Accordingly, there are also areas of the at least one cushion element in which a lower contact pressure of the occupant is to be expected. In order to minimise the negative impact on seating comfort by providing the openings, the openings are only provided in those areas of at least one cushion element in which a low contact pressure is to be expected. In those areas of the at least one cushion element in which a high contact pressure is to be expected, no opening is therefore provided. This ensures that seating comfort is not restricted.

According to a further preferred embodiment, a dimensioning of the respective openings has a proportionality to a hardness of the integral foam. Preferably, a dimension of each opening from the plurality of openings is inversely proportional to the hardness of the integral foam. Thus, if the integral foam has a lower hardness, each of the openings has a larger dimension than a corresponding opening in a cushion element with a greater hardness. An opening of the same type at a comparatively identical position in the at least one cushion element has smaller dimensions if an integral foam material with a greater hardness is selected.

By making the dimensions of the openings dependent on the hardness of the integral foam, it is ensured that the openings do not have a negative impact on seating comfort. The openings in the cushion element are dimensioned in such a way that they are not noticeable or only slightly noticeable. If, for example, a soft integral foam is used, which is subject to greater deformation by the occupant, larger dimensions are provided. Wider and/or longer openings are therefore preferred. If, on the other hand, a harder integral foam is used, which is less deformed by the occupant, the openings are smaller. Narrower and/or shorter openings are therefore provided.

Preferably, at least one cushion element extends along a height axis Z′, a width axis Y′ and along a longitudinal axis X′. The backrest element is provided at a rear section of the vehicle seat along the longitudinal axis X′. A front section of the vehicle seat along the longitudinal axis X′ points forwards along the occupant's normal line of vision. If necessary, the front section points towards any controls of the commercial vehicle. The width axis Y′ extends the lateral boundaries of the vehicle seat.

Accordingly, an opening in the at least one cushion element is an opening in the cushion element which runs along the entire height of the cushion element essentially along the height axis Z′.

According to a further preferred embodiment, a centre axis is provided with respect to the width axis Y′. Preferably, an arrangement of the openings in the at least one cushion element is symmetrical to the centre axis with respect to the width axis Y′. This advantageous symmetrical arrangement of the openings ensures improved seating comfort, as there are no imbalances with respect to the right or left side on the vehicle seat.

According to a preferred embodiment, the support structure comprises a first shell element on which at least one first cushion element is arranged. Preferably, the support structure comprises a second shell element on which at least one second cushion element is arranged. Preferably, the first shell element and the at least one first cushion element form a seat part of the vehicle seat. It is conceivable that several first cushion elements are arranged on the first shell element. Thus, the first shell element and the plurality of first cushion elements would form the seat part of the vehicle seat. Preferably, the second shell element and the at least one second cushion element form a back part of the vehicle seat. It would also be conceivable that several second cushion elements are arranged on the second shell element. In this way, the second shell element and the several second cushion elements would form the back part of the vehicle seat. The first shell element and the second shell element can be made of a dimensionally stable plastic or a metal.

The support structure can advantageously further comprise a support element to which the first shell element and the second shell element are attached. The support element can preferably be arranged on the body of the commercial vehicle. It is also conceivable that the support element is designed in such a way that the back section can be tilted relative to the seat section. Preferably, an inclination adjustment device is provided, by means of which an inclination of the back section relative to the seat section can be adjusted.

According to a further preferred embodiment, the support structure comprises only one shell element on which at least one first cushion element and at least one second cushion element are arranged. Preferably, a first section of the shell element and the at least one first cushion element form a seat part of the vehicle seat. It is conceivable that several first cushion elements are arranged on the first section of the shell element. Thus, the first section of the shell element and the plurality of first cushion elements would form the seat part of the vehicle seat. Preferably, a second section of the shell element and the at least one second cushion element form a back part of the vehicle seat. It is conceivable that several second cushion elements are arranged on the second section of the shell element. Thus, the second section of the shell element and the several second cushion elements would form the back part of the vehicle seat. The shell element can be made of a dimensionally stable plastic or a metal.

According to a preferred embodiment, the vehicle seat has a short back section. With such a short back section, the back section does not extend over the shoulder area of the occupant. In the case of tractors or forklift trucks, it is often preferable that the back section does not extend to the shoulder area in an upright position. This allows the driver greater freedom of movement with regard to turning the upper body, which is advantageous when reversing, for example.

According to a further preferred embodiment, the at least one cushion element has a main section and at least one projecting section. Preferably, the at least one projecting section projects beyond the main section. Preferably, the projecting section projects beyond the main section essentially along the height axis Z′. The main section forms the section that is in contact with the occupant.

According to a further preferred embodiment, the at least one shell element has at least one trough-like mounting in which the at least one projecting section is arranged. Preferably, the at least one trough-like mounting is substantially complementary to the at least one projecting section. By arranging the projecting section in the trough-like mounting, a hold of the at least one cushion element on the at least one shell element is achieved.

According to a further preferred embodiment, the at least one cushion element is fastened to the at least one shell element by means of at least one screw-like fastening element. Preferably, the at least one screw-like fastening element engages directly in the integral foam.

Advantageously, the at least one screw-like fastening element engages directly in the integral foam. The at least one screw-like fastening element is thus in direct contact with the integral foam. The at least one screw-like fastening element is designed in such a way that a sufficiently stable fastening between the support structure and the at least one cushion element is ensured. A direct, insert-free foam screw connection is thus provided. Due to the absence of inserts, the at least one cushion element is unmixed. This makes it easier to feed it into a recycling process. Since neither gluing nor the provision of inserts is necessary, production is also simplified, which reduces manufacturing costs.

According to a particularly preferred embodiment, there is a detachable positive connection between the at least one screw-like fastening element and the at least one cushion element. In addition to the simpler manufacturing process, the components of a discarded vehicle seat can also be separated in a simple manner by loosening the screw-like fastening elements. In contrast to gluing, this type of separation is much simpler. The components can then be sorted and fed into a recycling process.

Preferably, the at least one screw-like fastening element engages in the projecting section. Further preferably, the at least one screw-like fastening element engages only in the projecting section. This means that the screw-like fastening element does not restrict the occupant's seating comfort in any way. The screw-like fastening element is therefore only provided in one area of the seat, namely the projecting section, which makes no contribution to the upholstery of the occupant, but serves exclusively to hold or fasten the at least one cushion element. Advantageously, the projecting section is designed in such a way that it has a greater hardness and/or a greater density than the main section. This can result in an improved hold of the fastening element, which is designed in the form of a screw.

The task is further solved by a commercial vehicle with a vehicle seat according to one of the embodiments described above. The commercial vehicle can be equipped with all the features already described above in the context of the vehicle seat, either individually or in combination with one another, and vice versa.

The utility vehicle is preferably a utility vehicle without a cab or with an open cab. For example, the commercial vehicle is a ride-on lawn mower, a tractor, a forklift truck or a construction vehicle.

According to a preferred embodiment, the vehicle seat is attached to the body of the commercial vehicle.

### BRIEF DESCRIPTION OF THE DRAWINGS

Further advantages, objectives and features of the present invention are explained with reference to the following description of the attached figures. Similar components may have the same reference signs in the various embodiments. The figures show:

FIG. 1 a perspective view of the vehicle seat according to one embodiment;

FIG. 2 a front view of the vehicle seat according to one embodiment;

FIG. 3 a side view of the vehicle seat according to one embodiment;

FIG. 4 a top view of the vehicle seat according to one embodiment;

FIG. 4 a sectional view of the vehicle seat according to one embodiment;

FIG. 6 a perspective view of two cushion elements according to one embodiment;

FIG. 7 a front view of two cushion elements according to one embodiment;

FIG. 8 a side view of two cushion elements according to one embodiment;

FIG. 9 a top view of two cushion elements according to one embodiment;

FIG. 10 a sectional view of the vehicle seat according to one embodiment;

FIG. 11 a sectional view of the vehicle seat according to one embodiment;

FIG. 12 a sectional view of a screw-like fastening element arranged in the cushion element according to one embodiment; and

FIG. 13 a sectional view of a screw-like fastening element arranged in the cushion element according to one embodiment;

In the figures, identical components are to be understood with the corresponding reference signs. For the sake of clarity, components may not be labelled with a reference sign in some figures, but have been designated elsewhere.

### DETAILED DESCRIPTION

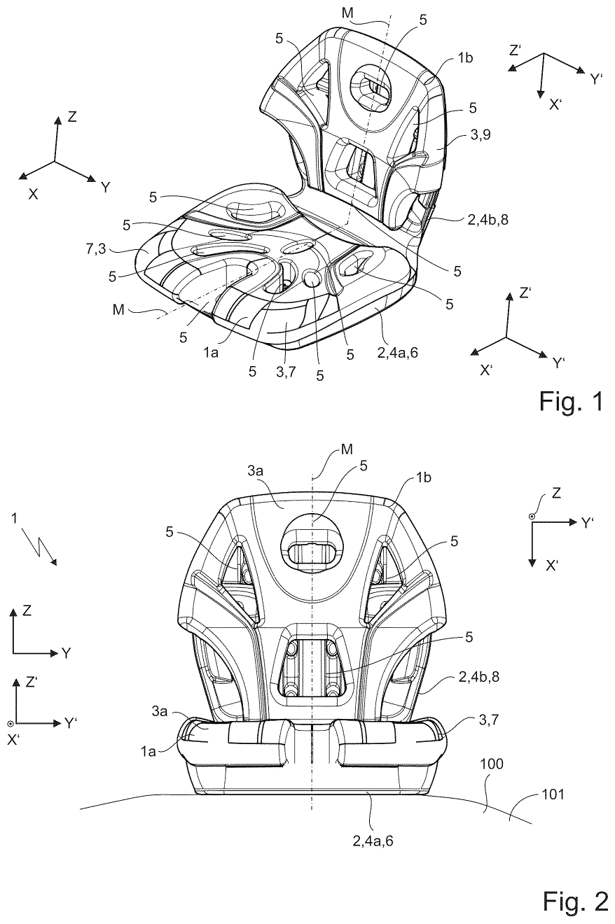

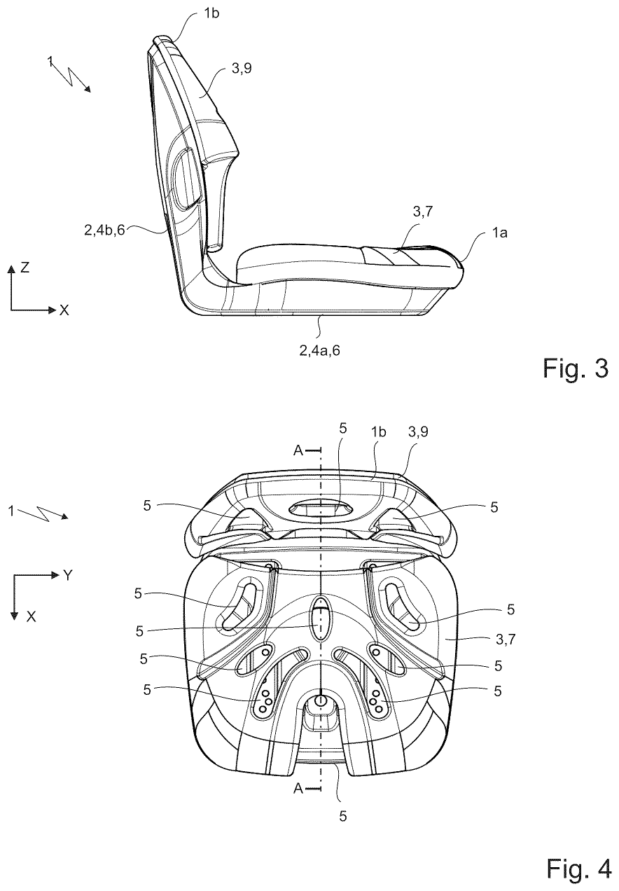

FIGS. 1-5, 11 show a vehicle seat 1 for commercial vehicles 100, comprising a support structure 2 and at least one cushion element 3, wherein the at least one cushion element 3 is arranged on the support structure 2, wherein the support structure 2 comprises at least one shell element 4, wherein the at least one cushion element 3 is formed from an integral foam, wherein the at least one cushion element 3 has a plurality of openings 5.

The vehicle seat extends along a longitudinal axis X, a width axis Y and a height axis Z. Advantageously, the vehicle seat 1 is attached to a section of the body 101 of a commercial vehicle 100. This is indicated in FIG. 2.

The vehicle seat 1 comprises a seat part 1a and a back part 1b. The support structure 2 can be of different designs:

According to one embodiment, the support structure 2 comprises a first shell element 10 and a second shell element 12. According to another embodiment, the support structure 2 comprises only one shell element 4.

According to the first-mentioned embodiment, at least one first cushion element 7 is arranged on the first shell element 6. Furthermore, at least one second cushion element 9 is arranged on the second shell element 8. The first shell element 6 and the at least one first cushion element 7 form the seat part 1a of the vehicle seat 1. It is conceivable that several first cushion elements 7 are arranged on the first shell element 6 and together form the seat part 1a. The second shell element 8 and the at least one second cushion element 9 form the back part 1b. It is conceivable that several second cushion elements 9 are arranged on the second shell element 8 and together form the back part 1b. The two shell elements 6, 8 can be connected to each other by means of a support element. This support element could be arranged on the body 101 of the commercial vehicle 100 and thus serve to attach the vehicle seat 1 to the body 101.

According to the further embodiment, only one shell element 4 is provided. The shell element 4 comprises a first section 4a and a second section 4b. The first section 4a, together with at least one first cushion element 7, forms the seat part 1a. It is conceivable that several first cushion elements 7 are arranged on the first section 4a and together form the seat part 1a. The second section 4b forms the back part 1b together with the at least one second cushion element 9. It is conceivable that several second cushion elements 9 are arranged on the second section 4b and together form the back part 1b. According to this embodiment, the shell element 4 can be arranged directly on the body 101. However, it would also be conceivable that a support element is provided, by means of which the attachment to the body 101 takes place.

The shell elements 4, 6, 8 are so-called hard shells and are made of a dimensionally stable plastic, metal or metal alloy.

The at least one cushion element 3 extends along a height axis Z′, which corresponds to a thickness of the at least one cushion element 3. Furthermore, the at least one cushion element extends along a longitudinal axis X′ and a width axis Y′. The respective openings are openings along the entire length of the at least one padding element along the height axis Z′. The width axis Y′ is preferably parallel to the width axis Y of the vehicle seat 1. A centre axis M can be defined with respect to the width axis Y′.

The openings 5 are provided in areas of the at least one cushion element 3 in which a lower contact pressure of the occupant on the at least one cushion element 3 is to be expected. In addition, the dimensions of the respective openings 5 are proportional to the hardness of the integral foam. Such a design ensures that the openings do not restrict seating comfort. At the same time, the provision of openings has several advantages: Firstly, passive ventilation is provided for the occupant. The openings reduce the surface area that the occupant comes into contact with. This makes it possible to regulate the temperature between the vehicle seat and the occupant, as the temperature can be regulated by exchanging air via the openings. It is also advantageous that less dirt or moisture can accumulate on the surfaces of the cushion element that are intended to come into contact with the occupant. These can be drained away through the openings.

The arrangement of the openings 5 in the at least one cushion element 3 is symmetrical to a centre axis M with respect to the width axis Y′. This also ensures seating comfort, as the occupant perceives a symmetrical structure.

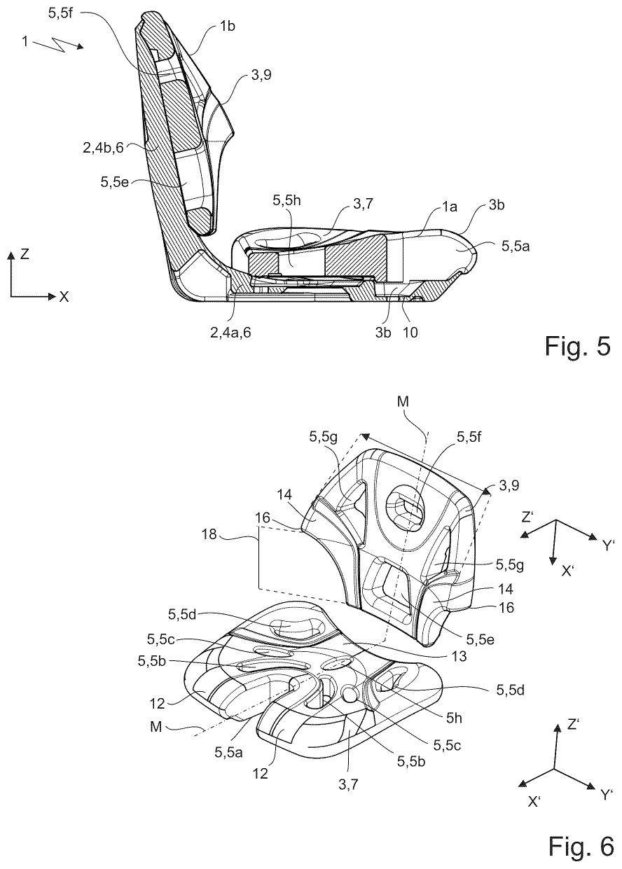

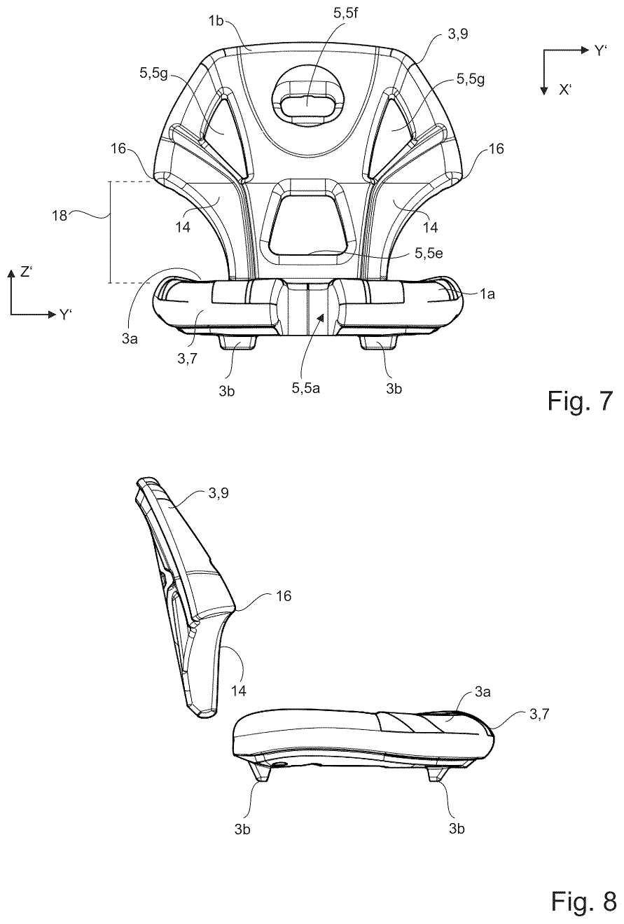

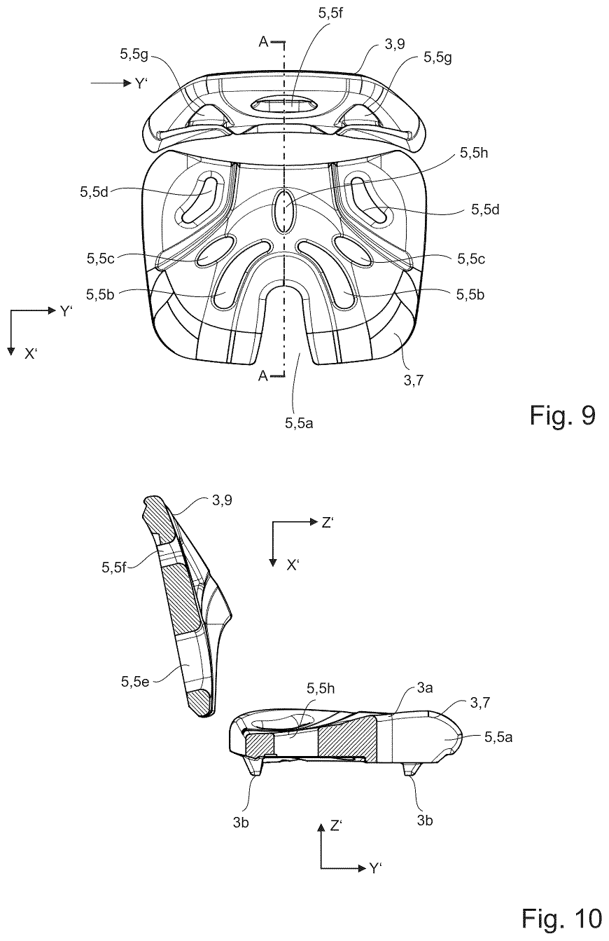

FIGS. 1 to 4 show a vehicle seat 1 with one or more shell elements 4, 6, 7, on each of which a first cushion element 7 and a second cushion element 9 are provided. FIG. 5 shows a corresponding sectional view of the vehicle seat, in which it can be seen that the openings 5 are continuous along the height axis Z′. In FIGS. 6 to 10, the first cushion element 3, 7 and the second cushion element 3, 9 are each shown without shell elements 4, 6, 8.

The first cushion element 3, 7 forming the seat part 1a has a first opening 5, 5a which is open forwards along the longitudinal axis X′. The first opening 5, 5a is arranged between two first supporting areas 12. The occupant's thighs rest on the first supporting areas 12, with the first supporting areas 12 representing areas of the seat part 1a on which a high contact pressure is exerted by the occupant. The intermediate area of the seat part 1a, in which the first opening 5, 5a is provided, is an area on which a low contact pressure acts. The opening 5, 5a is open at the front along the longitudinal axis X′, extends longitudinally along the longitudinal axis X′ and is bounded at the rear along the longitudinal axis X′ by a rounded end. A front section of the first cushion element 3, 7 is thus fork-shaped.

The first cushion element 3, 7 further comprises two second openings 5, 5b. The two second openings 5, 5b have an arcuate cross-sectional area and are arranged symmetrically to the centre axis M. The inside of the arch continues to face the first opening 5, 5a. A first rear end of the two second openings 5, 5b has a first distance from the centre axis M. A second front end of the two second openings 5, 5b is at a second distance from the centre axis M. The second distance is greater than the first distance. The respective second front end of a second opening 5, 5b adjoins a respective first supporting area 12. The two first rear ends of the second openings 5, 5b are arranged along the longitudinal axis X′ behind the first opening 5, 5a. The arcuate cross-sectional surface essentially extends outwards from the centre axis M and partially surrounds the first opening 5, 5a.

The first cushion element 3, 7 further comprises two third openings 5, 5c. These are each spaced apart from an outer boundary of a second opening 5, 5b by means of a web-like section of the first cushion element 3, 7. The two third openings 5, 5c have an elliptical base. A main axis of the ellipse runs diagonally outwards away from the centre axis M. The two third openings 5, 5c are arranged symmetrically with respect to the centre axis M.

The first cushion element 3, 7 further comprises a fourth opening 5, 5h. This has an elliptical base surface and is arranged symmetrically on the centre axis M. Furthermore, the fourth opening 5, 5h is arranged in a rear region of the first cushion element 3, 7 between the two second supporting areas 13. The two second supporting areas 13 serve to support the ischial tuberosities of the occupant. The two second supporting areas 13 are areas of the seat part 1a on which a high contact pressure is exerted by the occupant. The intermediate area of the seat part 1a, in which the fourth opening 5, 5h is provided, is an area on which a low contact pressure acts.

Finally, the first cushion element 3, 7 comprises two fifth openings 5, 5d. The two fifth openings 5, 5d have an arcuate cross-sectional area and are arranged symmetrically to the centre axis M. An inner side of the arch-like cross-sectional surface faces outwards. An outer side of a respective arch-like cross-sectional area adjoins a second supporting area 13. The fifth openings 5, 5d are arranged in a region of the first cushion element 3, 7, which is formed as a curvature directed upwards along the height axis Z′. Such a curvature serves to laterally support the buttocks of the occupant.

The second cushion element 3, 9 forming the back part 1b has a sixth opening 5, 5e. The sixth opening 5, 5e has a trapezoidal cross-sectional area. An upper side of the trapezoidal cross-sectional area along the height axis Z′ is shorter than a lower side along the height axis Z′. The sixth opening 5, 5e is arranged symmetrically on the centre axis M in a lower region of the second cushion element 3, 9, which is adjacent to the lumbar vertebrae region of the occupant. This allows a corresponding temperature equalisation in the lumbar region.

A third lateral contact surface 14 adjoins the sixth opening 5, 5e. The third contact surfaces 14 serve to support the back in the lumbar region. The third contact surfaces 14 are areas of the second cushion element 3, 9 in which the occupant is expected to exert increased contact pressure. The third contact surfaces 14 have a curved shape. The second cushion element 3, 9 has a first width extension 15 at its lower end along the height axis Z′. Due to the arcuate shape of the third contact surfaces 14, the width extension increases along the height axis Z′ up to a respective peak 16 of the third contact surfaces 14. The two peaks 16 are spaced apart by a second width extension 17. The second width extension 17 is greater than the first width extension 15. The increase in width extension along the width axis Y′ takes place along a curved shape up to the two peaks 16 on the left and right sides of the second cushion element 3, 9. The two peaks on the left and right sides are essentially at the same height 18 as an upper end of the sixth opening 5, 5e. A width extension starting from the second width extension 17 decreases upwards along the height axis Z′ to an upper end of the second cushion element 3, 9.

The second cushion element 3, 9 comprises a seventh opening 5, 5f, which has a substantially rectangular cross-sectional area. The seventh opening 5, 5f is arranged along the height axis Z′ above the sixth opening 5, 5e.

Finally, the second cushion element 3, 9 comprises two eighth openings 5, 5g. The two eighth openings 5, 5g have a substantially triangular cross-sectional area and are arranged symmetrically to the centre axis M. A lower end of the eighth openings 5, 5g lies essentially at the height 18 at which the peaks 16 also lie. An upper end of the eighth openings 5, 5g ends at the level of the seventh opening 5, 5e.

The at least one cushion element 3 can have a main section 3a and at least one projecting section 3b. The main section 3a comprises the surface which is in contact with the occupant and the material portion of the cushion element 3 which is intended to provide the elasticity or cushioning. The main section 3a thus has a certain thickness. The main section 3a can also have a varying thickness.

The main section 3a of a first cushion element 7, i.e. a cushion element for the seat part, can have side carriages which serve to support the thighs of the occupant. The main section 3a of a second cushion element 9, i.e. a cushion element for the back section, can have side carriages which serve to support the occupant's back. Other configurations, such as curvatures etc., which promote ergonomic sitting would also be conceivable. The at least one projecting section 3b protrudes beyond the main section 3a. Preferably, the at least one projecting section 3b projects beyond the main section 3a along the height axis Z′ of the at least one cushion element 3.

The at least one shell element 4, 6, 8 can have at least one trough-like mounting 10. This trough-like mounting 10 is intended and designed to receive at least one projecting section 3b of the cushion element 3. Preferably, the at least one trough-like mounting 10 is essentially complementary to the at least one projecting section 3b. This preferably enables a positive fit to be realised, which provides a hold of the at least one cushion element 3 on the shell element 4, 6, 8.

In the embodiments shown in the figures, the projecting sections 3b are essentially cylindrical with a rectangular or square cross-section. Complementing this, the trough-like mountings 14 also have a rectangular or square cross-section.

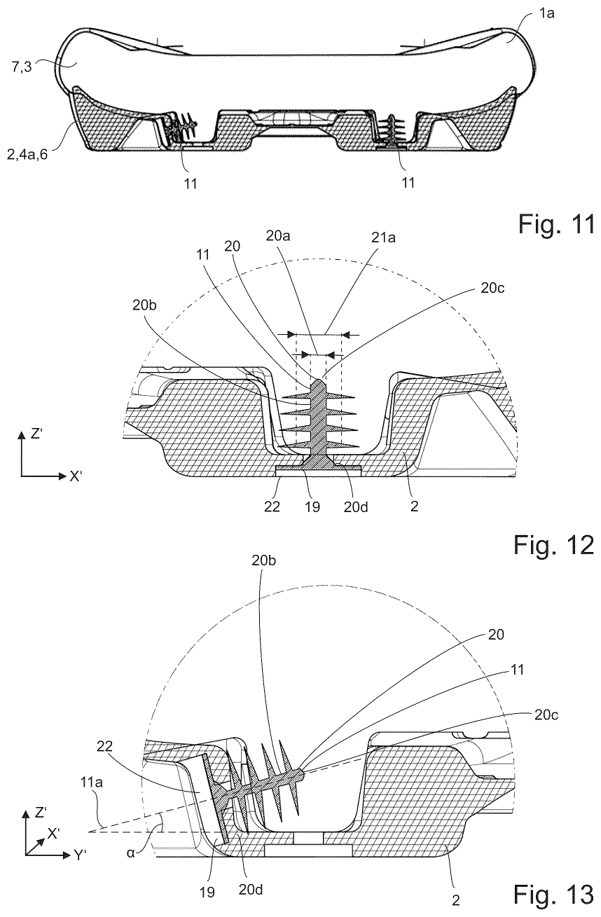

According to an embodiment as shown in FIGS. 11 to 12, the at least one cushion element 3 is fastened to the at least one shell element 4, 6, 8 by means of at least one fastening element 11 of screw-like design. The at least one screw-like fastening element 11 engages directly in the integral foam.

There is a detachable positive connection between the at least one screw-like fastening element 11 and the at least one cushion element 3. This detachable connection allows the at least one cushion element 3 to be removed from the at least one shell element 4, 6, 8 in a very simple manner. On the one hand, this has the advantage that the at least one cushion element 3 can be replaced in a simple manner. Furthermore, the components of a discarded vehicle seat 1 can be separated very easily. The separated components are then unmixed. This means, for example, that the at least one cushion element 3 does not contain any other elements, such as inserts, that need to be removed before a recycling process. The components can therefore be fed into a recycling process in a simple manner.

As can be seen in FIGS. 12 and 13, the screw-like fastening element 5 has a plate-like end section 19. A core section 20 is arranged on the disc-shaped end section 19. This core section 20 has a pin-like region 20b. At one end, this merges into a needle-shaped conical tip 20c. At the opposite end, the pin-shaped area 20b merges into a transition area 20d, which is essentially conical in shape. The transition area 20d merges into the end section 19 of the screw-like fastening element 11.

A self-tapping external threaded section 21 is arranged on the core section 20. By screwing in the screw-like fastening element 11, a positive fit is thus cut into the integral foam. The core section 20 has a minor diameter 20a in its pin-like area 20b. The externally threaded section 21 has a pitch diameter 21a. The pitch diameter 21a is larger than the minor diameter 20a by at least a factor of 2, preferably by at least a factor of 3, more preferably by at least a factor of 4. Such a deep external threaded section 8 21 ensures mechanical strength of the form-fit connection between the screw-like fastening element 11 and the integral foam. The respective flanks of the externally threaded section 21 preferably have a sawtooth shape. The respective flanks have a lower surface which faces the end section 19 and is essentially parallel to it. The lower surface forms an angle with an upper surface. This angle is an acute angle, which lies in a range between 2° and 10°. The externally threaded section 21 also has an outer diameter, which is the maximum diameter of the externally threaded section 21. The outer diameter of the externally threaded section 21 advantageously decreases continuously in a direction starting from the end section 9 towards the tip 20c of the core section 20. The fastening element 11 thus preferably has a substantially conical shape.

The at least one screw-like fastening element 11 is arranged in a mounting 22 of the shell element 4, 6, 8. The mounting 22 has a first section in which the disc-shaped end section 19 is arranged. This first section is adjoined by a second section in the form of an opening through the shell element 4, 6, 8. The screw-like fastening element 11 protrudes through this opening. Preferably, a part of the core section 20 is arranged in the opening. According to the embodiment, the core section 20 has a transition region 20d, in which the minor diameter increases in the direction towards the end section 19. Preferably, this transition region 20d is conical in shape. The conical transition region 20d is partially in contact with an inner surface of the second section in the form of an opening. The end section 19 lies against an inner surface of the first section. In a screwed-in state of the screw-like fastening element 11, the at least one cushion element 3 is thus held by this contact of the end section 19. The at least one cushion element 3 then rests at least partially against an inner surface of the shell element 4, 6, 8. The mounting 22 is essentially T-shaped.

The screw-like fastening element 11 can be arranged in such a way that it extends essentially vertically, i.e. essentially along a height axis Z′, into the at least one cushion element 3. This is shown, for example, in FIG. 12, 8. The screw-like fastening element 11 can also be screwed into the at least one cushion element 3 at an upward angle. A centre axis 11a of the screw-like fastening element 11 thus forms an angle α with a plane spanned by the longitudinal axis X′ and the width axis Y′. This angle α is preferably in a range between 1° and 80°, more preferably in a range between 20° and 70°.

The at least one screw-like fastening element 11 preferably engages exclusively in the projecting section 3b. This has the advantage that the cushioning properties in the main section 3a of the at least one cushioning element 3 are not impaired by the screw-like fastening element 11. It is also conceivable that the properties of the at least one cushion element 3 in the projecting section 3b differ from the main section 3a. For example, the projecting section 3b may have a greater hardness or density. This can provide an improved hold of the screw-like fastening element 5. In FIG. 12, the fastening element 11 is arranged essentially vertically in the projecting section 3b. In FIG. 13, the fastening element 11 is rotated at an angle in the projecting section 3b

The trough-like mountings 10 are clearly recognisable in FIGS. 5 and 11. Of course, the trough-like mountings 10 can be provided both in the first section 4a and in the second section 4b of a one-piece shell element 4 as well as in the first shell element 6 and the second shell element 8. The at least one mounting 22 for the screw-like fastening element 11 can be arranged in the trough-like mountings 10.

The applicant reserves the right to claim all features disclosed in the application documents as being essential to the invention, provided that they are new, either individually or in combination, compared to the prior art. It should also be noted that the individual figures also describe features which may be advantageous in themselves. The skilled person immediately recognises that a particular feature described in a figure can also be advantageous without the adoption of further features from this figure. Furthermore, the skilled person recognises that advantages can also result from a combination of several features shown in individual figures or in different figures.

List of reference symbols

| | |
|---|---|
| 1 | Vehicle seat |
| 2 | Support structure |
| 3 | Cushion element |
| 3a | Main section of the cushion element |
| 3b | Projecting section of the cushion element |
| 4 | Shell element |
| 4a | First section of the shell element |
| 4b | Second shell element |
| 5 | Opening |
| 5a | First opening |
| 5b | Second opening |
| 5c | Third opening |
| 5d | Fifth opening |
| 5e | Sixth opening |
| 5f | Seventh opening |
| 5g | Eighth opening |
| 5h | Fourth opening |
| 6 | First shell element |
| 7 | First cushion element |
| 8 | Second shell element |
| 9 | Second cushion element |
| 10 | Mounting for the projecting section |
| 11 | Screw-type fastening element |
| 11a | Centre axis of the fastening element |
| 12 | First supporting areas |
| 13 | Second supporting areas |
| 14 | Third supporting areas |
| 15 | First width extension |
| 16 | Peaks |
| 17 | Second width extension |
| 18 | Height |
| 19 | End section of the fastening element |
| 20 | Core section of the fastening element |
| 7a | Minor diameter |
| 20b | Pin-shaped area of the core section |
| 20c | Tip of the core section |
| 20d | Transition area of the core section |
| 21 | External threaded section |
| 21a | Pitch diameter |
| 22 | Mounting |
| 100 | Commercial vehicle |
| 101 | Car body |
| α | Angle |
| X | Longitudinal axis of the vehicle seat |
| Y | Width axis of the vehicle seat |
| Z | Height axis of the vehicle seat |
| X′ | Longitudinal axis of the cushion element |
| Y′ | Width axis of the cushion element |
| Z′ | Height axis of the cushion element |

1. Vehicle seat (1) for commercial vehicles (100) comprising a support structure (2) and at least one cushion element (3), wherein the at least one cushion element (3) is arranged on the support structure (2),
wherein
the support structure (2) comprises at least one shell element (4), wherein the at least one cushion element (3) is formed from an integral foam, wherein the at least one cushion element (3) has a plurality of openings (5).

2. Vehicle seat (1) according to claim 1,
wherein
the openings (5) are provided in areas of the at least one cushion element (3) in which a lower contact pressure of the occupant on the at least one cushion element (3) is to be expected.

3. Vehicle seat (1) according to claim 1,
characterised in that wherein
a dimensioning of the respective openings (5) has a proportionality to a hardness of the integral foam.

4. Vehicle seat (1) according to one of the preceding claims claim 1,
characterised in that wherein
the at least one cushion element extends along a width axis Y′ and along a longitudinal axis X′, wherein an arrangement of the openings (5) in the at least one cushion element (3) is symmetrical to a centre axis (M) with respect to the width axis Y′.

5. Vehicle seat (1) according to claim 1,
wherein
the support structure (2) comprises a first shell element (6), on which at least one first cushion element (7) is arranged, wherein the support structure (2) comprises a second shell element (8), on which at least one second cushion element (9) is arranged, wherein the first shell element (6) and the at least one first cushion element (7) form a seat part (1a) of the vehicle seat (1), wherein the second shell element (8) and the at least one second cushion element (9) form a back part (1b) of the vehicle seat (1).

6. Vehicle seat (1) according to claim 1,
wherein
the support structure (2) comprises only one shell element (4), on which at least a first cushion element (7) and at least a second cushion element (9) are arranged, wherein a first section (4a) of the shell element (4) and the at least one first cushion element (11) form a seat part (1a) of the vehicle seat (1), wherein a second section (4b) of the shell element (4) and the at least one second cushion element (13) form a back part (1b) of the vehicle seat (1).

7. Vehicle seat (1) according to claim 1,
wherein
the at least one cushion element (3) has a main section (3a) and at least one projecting section (3b), wherein the at least one projecting section (3b) projects beyond the main section (3a).

8. Vehicle seat (1) according to claim 1,
wherein
the at least one shell element (4, 6, 8) has at least one trough-like mounting (10) in which the at least one projecting section (3b) is arranged, wherein the at least one trough-like mounting (10) is formed substantially complementary to the at least one projecting section (3b).

9. Vehicle seat (1) according to claim 8, wherein
the at least one cushion element (3) is fastened to the at least one shell element (4, 6, 8) by means of at least one screw-like fastening element (11), wherein the at least one screw-like fastening element (11) engages directly in the integral foam.

10. Commercial vehicle with a vehicle seat (1) according to claim 1.
